(19) United States
(12) Patent Application Publication
(10) Pub. No.: US 2023/0364720 A1
(43) Pub. Date: Nov. 16, 2023

(54) BRAZING PASTE

(71) Applicants: SENJU METAL INDUSTRY CO., LTD., Tokyo (JP); TOYOTA JIDOSHA KABUSHIKI KAISHA, Aichi-ken (JP)

(72) Inventors: Yoshie TACHIBANA, Tokyo (JP); Hiroshi KAWANAGO, Tokyo (JP); Takashi AKAGAWA, Tokyo (JP); Satoshi MASUDA, Tokyo (JP); Masaki SUGIYAMA, Toyota-shi (JP); Yosuke KAZUMOTO, Toyota-shi (JP); Hisaya SUGIMOTO, Nagoya-shi (JP); Hiroaki HATSUYAMA, Toyota-shi (JP)

(73) Assignees: SENJU METAL INDUSTRY CO., LTD., Tokyo (JP); TOYOTA JIDOSHA KABUSHIKI KAISHA, Aichi-ken (JP)

(21) Appl. No.: 18/142,736

(22) Filed: May 3, 2023

(30) Foreign Application Priority Data
May 10, 2022 (JP) 2022-077479

(51) Int. Cl. B23K 35/02; B23K 35/36; B23K 35/30

(52) U.S. Cl. CPC B23K 35/025; B23K 35/3612; B23K 35/302; B23K 35/3053

(57) ABSTRACT

A brazing paste contain 80% by mass or more and 95% by mass or less of a brazing material; and 5% by mass or more and 20% by mass or less of a binder. The binder contains a solid solvent containing two or more hydroxyl groups and having 5 to 7 carbon atoms, and a liquid solvent.

### TECHNICAL FIELD

The present invention relates to a brazing paste.

The present application claims the priority of Japanese Patent Application No. 2022-077479 filed on May 10, 2022, the contents of which are entirely incorporated by reference.

### BACKGROUND ART

Conventionally, brazing materials have been used to join members, particularly metal members. For example, JP 2021-76224 A discloses an aspect in which a pipe member is joined to a joint body by brazing using nickel solder, silver solder, or the like in a state where an end of the pipe member is inserted into an opening of a joint member. JP 2021-76224 A discloses that brazing is performed along a boundary between the opening and an outer peripheral surface of the pipe member on an end surface of the joint body, and a brazing material that has been melted and become liquid enters a slight gap between an inner peripheral surface of the opening and the outer peripheral surface of the pipe member due to a capillary phenomenon, and the brazing material that has entered decreases in temperature and is cured, whereby the end of the pipe member and the joint body are joined by brazing.

### SUMMARY OF INVENTION

### Problem to be Solved by Invention

In the joining using brazing materials, joining is generally performed using pelletized brazing materials. Since such pelletized brazing materials do not have high workability, use scenes have been limited. Note that it is also necessary to provide a recess to place a pelletized brazing material in a case where the pelletized brazing material is used.

In order to improve such a situation, the present invention provides a paste-like brazing material which can achieve high workability.

### Means for Solving Problem

### [Concept 1]

A brazing paste may comprise:
80% by mass or more and 95% by mass or less of a brazing material; and
5% by mass or more and 20% by mass or less of a binder,
wherein the binder may contain a solid solvent containing two or more hydroxyl groups and having 5 to 7 carbon atoms, and a liquid solvent.

### [Concept 2]

A brazing paste may comprise:
a brazing material in an amount of 80% by mass or more and 95% by mass or less; and
a binder in an amount of 5% by mass or more and 20% by mass or less,
wherein the binder may contain a solid solvent containing two or more hydroxyl groups and having 8 to 10 carbon atoms, and a liquid solvent,
(1) when the binder does not contain a thixotropic agent, the liquid solvent is contained in an amount of 68% by mass or more with respect to a total of the binder, and
(2) when the binder contains a thixotropic agent, the thixotropic agent is contained in an amount of 11% by mass or less with respect to a total of the binder.

### [Concept 3]

In the brazing paste according to concept 1 or 2,
the brazing material may contain metal,
an oxygen concentration in the metal may be 1000 ppm or less, and
the brazing material may not contain boric acid and borax.

### [Concept 4]

In the brazing paste according to any one of concepts 1 to 3,
a TG residue at 250° C. when being measured at a temperature increase rate of 10° C./min from 25° C. to 450° C. may be 0% by mass or more and 1% by mass or less.

### [Concept 5]

The brazing paste according to any one of concepts 1 to 4 may contain any one or more of 2,5-dimethyl-2,5-hexanediol, trimethylolpropane, and neopentyl glycol as the solid solvent of the binder.

### [Concept 6]

The brazing paste according to any one of concepts 1 to 5 may contain any one or more of terpineol, isobornyl cyclohexanol, butyl carbitol, tripropylene glycol monobutyl ether, phenyl glycol, hexylene glycol, tetraethylene glycol dimethyl ether, and isooctadecanol as the liquid solvent of the binder.

According to the present invention, provided is the paste-like brazing material which can achieve sufficient joining and has the high workability.

### BRIEF DESCRIPTION OF DRAWINGS

FIG. 1 is a side view illustrating an aspect in which metal parts are joined together using a brazing paste according to the present embodiment.

### DETAILED DESCRIPTION

Hereinafter, a preferred embodiment of the present embodiment will be described in detail. In the present embodiment, “or” is a concept including “and”, and A or B represents either A or B, or both A and B.

A paste-like brazing paste of the present embodiment may contain a brazing material and a binder. The brazing material may contain metal. The binder may contain a solid solvent and a liquid solvent, and may further contain a thixotropic agent. An aspect in which the brazing material of the present embodiment does not contain boric acid and borax as fluxes may be employed. An aspect in which the metal such as a metal powder contained in the brazing material contains only low oxygen at 1000 ppm or less may be employed. Boric acid and borax act as reducing agents, but boric acid and borax are not particularly necessary when the metal such as the metal powder contains only low oxygen at 1000 ppm or less. From this viewpoint, an aspect in which the metal such as the metal powder contains only oxygen at 800 ppm or less is preferable, and an aspect of containing only oxygen at 600 ppm or less is more preferable. Note that there is a possibility that the use of boric acid and borax is restricted, and thus, to employ the aspect of not containing boric acid and borax is also advantageous in this sense. In addition, in the case of not using boric acid and borax, it is unnecessary to select a solid solvent compatible with boric acid and borax, and as a result, a range of selection of a liquid solvent is also widened, which is also advantageous.

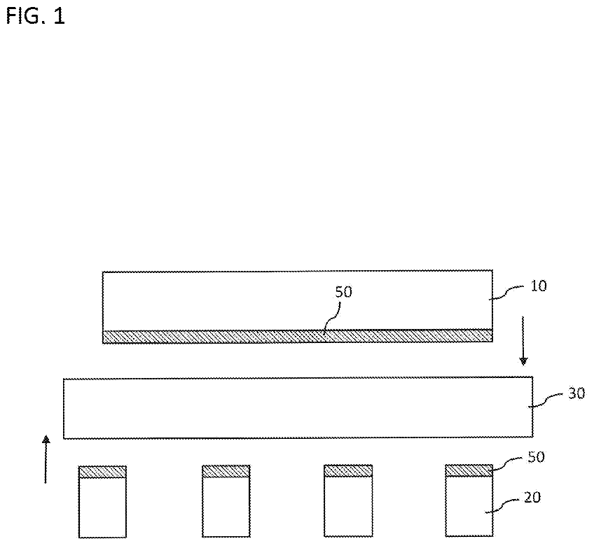

In the present embodiment, the brazing paste can be provided. The use of such a brazing paste enables direct application to a joining part to ensure wetting, and acquisition of stable joining quality. In addition, parts to be molded can be miniaturized and simplified, and processing accuracy and yield per part can be improved. Furthermore, due to adhesiveness of the brazing paste, it is easier to stack and join smaller parts like bricks, and various applications become possible even in a mass production stage. As an example, a brazing paste 50 of the present embodiment is used when metal parts 10 and 20 as illustrated in FIG. 1 are joined to another metal part 30. For example, the brazing paste is spread on the surfaces of the metal parts 10 and 20 and used when the metal parts 10 and 20 are joined to the other metal part 30. Such joining is performed at a temperature of 450° C. or higher, and typically, the metal parts are bonded at 900 to 1000° C. As an example, the brazing paste 50 may be used for joining of constituent parts of an automatic transmission.

The brazing paste may contain 80% by mass or more and 95% by mass or less of the brazing material and 5% by mass or more and 20% by mass or less of the binder. The binder evaporates and disappears at the time of joining, and thus, a ratio between the brazing material and the binder is not particularly limited as will be described later. Since the viscosity decreases and workability decreases when a content of the binder is high, an upper limit of the binder is preferably 20% by mass, more preferably 15% by mass, and still more preferably 10% by mass. In addition, the viscosity increases and the workability also decreases when the content of the binder is low, and thus, a lower limit of the binder is preferably 5% by mass, more preferably 7% by mass, and still more preferably 8% by mass.

As the solid solvent of the binder, one containing two or more hydroxyl groups, having 5 to 10 carbon atoms, and being solid at 25° C. may be used. As the solid solvent having 5 to 7 carbon atoms, trimethylolpropane, neopentyl glycol, or the like may be used. As the solid solvent having 8 to 10 carbon atoms, for example, 2,5-dimethyl-2,5-hexanediol or the like may be used.

As the liquid solvent of the binder, a liquid solvent having a low boiling point in which a boiling point is 250 or less may be used. As the liquid solvent of the binder, for example, terpineol, isobornyl cyclohexanol, butyl carbitol, tripropylene glycol monobutyl ether, phenyl glycol, hexylene glycol, tetraethylene glycol dimethyl ether, isooctadecanol, or the like may be used. The liquid solvent in the present embodiment means a solvent in a liquid state at 25° C., and the solid solvent means a solvent in a solid state at 25° C.

A boiling point of isobornyl cyclohexanol is 302° C. and is high, but the boiling point of the liquid solvent illustrated below is low.

A boiling point of α-terpineol is 217° C.

A boiling point of butyl carbitol is 198° C.

A boiling point of tripropylene glycol monobutyl ether is 230° C.

A boiling point of phenyl glycol is 220° C.

A boiling point of hexylene glycol is 190° C.

A boiling point of tetraethylene glycol dimethyl ether is 240° C.

A boiling point of isooctadecanol is 302° C.

The metal of the brazing material may be introduced as a metal powder and mixed with the other members to form a paste. Since the brazing paste is in the paste form as described above, the metal powder is not recognizable as a powder with the naked eye. The metal may be an alloy powder, a metal powder, or a mixture of the alloy powder and the metal powder. The metal contained in the brazing material is not particularly limited, and any kind of metal can be used. Note that the metal contained in the brazing material may be appropriately changed according to a material of the metal part to be joined. As an example, a Cu-based alloy powder and an Fe-based metal powder may be used, and more specifically, a CuNiMnSiB alloy powder and an Fe powder may be used. The CuNiMnSiB alloy powder may contain 38.0 to 41.0% by mass of Cu, 40.0 to 43.0% by mass of Ni, 14.0 to 16.0% by mass of Mn, 1.6 to 2.0% by mass of Si, 1.3 to 1.7% by mass of B, and 1.0% by mass or less of the other components. Typically, the alloy powder is a main component of joining, and the metal powder is added to ensure wettability. When an Fe sheet metal is used, the Fe powder can ensure wettability to the Fe sheet metal.

As an example, an alloy powder and a metal powder are contained as the brazing material component. With respect to a total amount (100% by mass) of the brazing material component, 80 to 90% by mass of the alloy powder and 10 to 20% by mass of a metal powder may be contained with respect to the entire brazing material component (100% by mass).

The binder may contain a thixotropic agent. As the thixotropic agent, an amide component may be used, and as an example, stearic acid amide, toluamide, lauric acid amide, myristic acid amide, palmitic acid amide, or the like may be used.

As an example, any one or more of 2,5-dimethyl-2,5-hexanediol, trimethylolpropane, and neopentyl glycol, which are solid solvents, and any one or more of terpineol, isobornyl cyclohexanol, butyl carbitol, tripropylene glycol monobutyl ether, phenyl glycol, hexylene glycol, tetraethylene glycol dimethyl ether, and isooctadecanol, which are liquid solvents, may be contained as the binder component.

As a first aspect, the brazing paste contains 80% by mass or more and 95% by mass or less of a brazing material and 5% by mass or more and 20% by mass or less of a binder, and contains a solid solvent containing two or more hydroxyl groups and having 5 to 7 carbon atoms, and a liquid solvent. Note that the brazing paste may contain components other than these.

As a second aspect, the brazing paste contains 80% by mass or more and 95% by mass or less of a brazing material and 5% by mass or more and 20% by mass or less of a binder, the binder contains a solid solvent containing two or more hydroxyl groups and having 8 to 10 carbon atoms, and a liquid solvent, and (1) when the binder does not contain a thixotropic agent, the liquid solvent is contained in an amount of 68% by mass or more with respect to the entire binder, and (2) when the binder contains a thixotropic agent, the thixotropic agent is contained in an amount of 11% by mass or less with respect to the entire binder. Note that the brazing paste may contain components other than these.

In each of the first aspect and the second aspect, the brazing material may adopt an aspect not containing boric acid and borax.

As the binder component, the solid solvent may be contained in an amount of 10 to 90% by mass, and the liquid solvent may be contained in an amount of 10 to 90% by mass. As an example, the binder may contain 10 to 90% by mass of a solid solvent containing any one or more of trimethylolpropane and neopentyl glycol, and contain 10 to 90% by mass of a liquid solvent containing any one or more of terpineol, isobornyl cyclohexanol, butyl carbitol, tripropylene glycol monobutyl ether, phenyl glycol, hexylene glycol, tetraethylene glycol dimethyl ether, and isooctadecanol. In addition, as another example, the binder may contain a liquid solvent containing any one or more of terpineol, isobornyl cyclohexanol, butyl carbitol, tripropylene glycol monobutyl ether, phenyl glycol, hexylene glycol, tetraethylene glycol dimethyl ether, and isooctadecanol, contain 10 to 90% by mass of 2,5-dimethyl-2,5-hexanediol as a solid solvent, (1) contains 68% by mass or more of the liquid solvent with respect to the entire binder when the binder does not contain a thixotropic agent, and (2) contains 11% by mass or less of a thixotropic agent with respect to the entire binder when the binder contains the thixotropic agent.

Note that terpineol is contained, as an upper limit value, in an amount of preferably 64% by mass or less and more preferably 60% by mass or less with respect to the entire binder when terpineol is used as the single liquid solvent, 2,5-dimethyl-2,5-hexanediol is used as the solid solvent, and the binder does not contain a thixotropic agent. In this case, as a lower limit value, terpineol is contained in an amount of preferably 35% by mass or more, more preferably 40% by mass or more, and still more preferably 50% by mass or more with respect to the entire binder. This is because paste separation occurs so that paste storage performance deteriorates when a content of terpineol increases under such conditions. On the other hand, binder properties deteriorate when the content of terpineol decreases. In addition, when 2,5-dimethyl-2,5-hexanediol is not used as a solid solvent but another solid solvent is used, versatility of a liquid solvent is enhanced. In this case, a limit of a content of the liquid solvent is also moderate, and a lower limit value of the liquid solvent may be 5% by mass and more preferably 10% by mass, and an upper limit value of the content of the liquid solvent may be 75% by mass and more preferably 70% by mass.

When 2,5-dimethyl-2,5-hexanediol is used as the solid solvent, a lower limit value of 2,5-dimethyl-2,5-hexanediol in the binder component (in 100% by mass) is preferably 25% by mass and more preferably 30% by mass in order to achieve optimum softness and optimum tackiness (tackiness of 0.6 or more) as the paste. In addition, in the binder component, an upper limit value of 2,5-dimethyl-2,5-hexanediol is preferably 65% by mass, more preferably 50% by mass, and still more preferably 40% by mass.

When 2,5-dimethyl-2,5-hexanediol is used as the solid solvent, and any one or more of terpineol, isooctadecanol, and isobornyl cyclohexanol is used as the liquid solvent, a lower limit value of a total value (including a case of being zero without containing any of terpineol, isooctadecanol, and isobornyl cyclohexanol) of terpineol, isooctadecanol, and isobornyl cyclohexanol in the binder component (in 100% by mass) is preferably 45% by mass, and more preferably 50% by mass in order to achieve the optimum softness and the optimum tackiness (tackiness of 0.6 or more) as the paste. In addition, an upper limit value of the total value of terpineol, isooctadecanol, and isobornyl cyclohexanol in the binder component is preferably 75% by mass, and more preferably 70% by mass.

From the viewpoint of more reliably suppressing the residue of the binder at the time of joining the metal parts to each other, the thixotropic agent is contained in an amount of preferably 10% by mass or less, more preferably 6% by mass or less, and still more preferably 2% by mass or less with respect to the entire binder component.

### Examples

A CuNiMnSiB alloy powder was used as an alloy powder, and the powder having a particle size distribution of 22 μm to 44 μm and a D50 of 33 μm was used. Note that the CuNiMnSiB alloy powder contained 38.0 to 41.0% by mass of Cu, 40.0 to 43.0% by mass of Ni, 14.0 to 16.0% by mass of Mn, 1.6 to 2.0% by mass of Si, 1.3 to 1.7% by mass of B, and 1.0% by mass or less of the other components.

An Fe powder was used as a metal powder, and the powder having a particle size distribution of 75 μm or less and a D50 of 33 μm was used.

85% by mass of the CuNiMnSiB alloy powder and 15% by mass of the Fe powder were contained in 100% by mass of a brazing material. In addition, an oxygen concentration was 1000 ppm or less in the CuNiMnSiB alloy powder and the Fe powder. Since the oxygen concentration in the metal powder is low as described above, the brazing material does not contain the flux containing boric acid and borax.

A TG residue % at 175° C. was measured using Thermogravimetry-Differential Thermal Analysis TG-DTA manufactured by Hitachi High-Tech Corporation under condition that a temperature increase rate is 10° C./min from 25° C. to 450° C. The TG residue % affects joining strength. In the table, % represents a value at the TG residue at 175° C. It was evaluated as “0” when the TG residue at 175° C. was less than 1% by mass, and as “x” when the TG residue at 175° C. was 1% by mass or more.

Paste formation was confirmed by viscosity according to JIS and visual observation. It was evaluated as “o” when the viscosity was 50 to 160 Pas and the separation could not be confirmed by visual observation, and as “x” when the viscosity was outside the range of 50 to 160 Pas or the separation could be confirmed by visual observation.

Strength was measured using DFH210 (static torsion tester) manufactured by Saginomiya Seisakusho, Inc. When the strength is weak, the function as the bonding material is not fulfilled. It was evaluated as “0” when the strength was 7900 Nm or more, and as “x” when the strength was less than 7900 Nm. Note that a value at 175° C. is used in the present embodiment, but the determination may be made with a value higher than 175° C., and one with a residue at 220° C. being less than 1% by mass may be selected, or one having a residue at 250° C. being less than 1% by mass may be selected. However, in terms of the effect, it is preferable that the TG residue % at 250° C. be less than 1% by mass, it is more preferable that the TG residue % at 220° C. be less than 1% by mass, and it is still more preferable that the TG residue % at 175° C. be less than 1% by mass.

Binder components respectively formed using Examples 1 to 8 in Table 1 were prepared.

Next, 91% by mass of the brazing material component was mixed with 9% by mass of the binder component, and then, a TG residue at 175° C., paste formation, and strength were measured. Note that the brazing material component (100% by mass) is formed by mixing 85% by mass of the CuNiMnSiB alloy powder and 15% by mass of the Fe powder as described above, and the same applies to Examples 9 to 17 and Comparative Examples 1 to 6 to be described later.

TABLE 1

| | | Example 1 | Example 2 | Example 3 | Example 4 | Example 5 | Example 6 | Example 7 | Example 8 |
|---|---|---|---|---|---|---|---|---|---|
| Solid | Trimethylolpropane | 45 | | | | | | | 70 |
| solvent | | | | | | | | | |
| Solid | Neopentyl glycol | 45 | 70 | 70 | 70 | 70 | 70 | 70 | |
| solvent | | | | | | | | | |
| Liquid | Butyl carbitol | 10 | 30 | | | | | | |
| solvent | | | | | | | | | |
| Liquid | BFTG (tripropylene glycol | | | 30 | | | | | |
| solvent | monobutyl ether) | | | | | | | | |
| Liquid | Phenyl glycol | | | | 30 | | | | |
| solvent | | | | | | | | | |
| Liquid | Hexylene glycol | | | | | 30 | | | |
| solvent | | | | | | | | | |
| Liquid | Tetraethylene glycol | | | | | | 30 | | |
| solvent | dimethyl ether | | | | | | | | |
| Liquid | α-terpineol (terpineol) | | | | | | | 30 | 30 |
| solvent | | | | | | | | | |
| | Total | 100 | 100 | 100 | 100 | 100 | 100 | 100 | 100 |
| | TG | ∘ | ∘ | ∘ | ∘ | ∘ | ∘ | ∘ | ∘ |
| | Paste formation | ∘ | ∘ | ∘ | ∘ | ∘ | ∘ | ∘ | ∘ |
| | Strength | ∘ | ∘ | ∘ | ∘ | ∘ | ∘ | ∘ | ∘ |

As illustrated in Table 1, excellent results were obtained in terms of each of the TG, the paste formation, and the strength in all of Example 1 to 8. Note that, in a case where it is evaluated as “0” for the TG residue % at 175° C., naturally, the TG residue % at 250° C. is also 1% by mass or less. The same applies to the following.

Binder components respectively formed using Examples 9 to 17 in Table 2 were prepared.

As illustrated in Table 2, excellent results were obtained in terms of each of the TG, the paste formation, and the strength in all of Example 9 to 17.

TABLE 2

| | | Exam- | Exam- | Exam- | Exam- | Exam- | Exam- | Exam- | Exam- | Exam- |
|---|---|---|---|---|---|---|---|---|---|---|
| | | ple 9 | ple 10 | ple 11 | ple 12 | ple 13 | ple 14 | ple 15 | ple 16 | ple 17 |
| Solid | 2, [symbol] -dimethyl-2, [symbol] - | 35 | 35 | 35 | 30 | 30 | 30 | 30 | 30 | 30 |
| solvent | [symbol] | | | | | | | | | |
| Liquid | [symbol] | | | 5 | | | | | | |
| solvent | | | | | | | | | | |
| Liquid | [symbol] | 55 | 63 | 54 | 32.5 | 34 | 35 | 21.7 | 34 | 34 |
| solvent | | | | | | | | | | |
| Liquid | [symbol] | | | | 32.5 | 34 | 35 | 43.3 | 34 | 34 |
| solvent | | | | | | | | | | |
| [symbol] | [symbol] amide | 4 | 0.8 | 2.4 | 2 | 0.8 | | 2 | 2 | |
| agent | | | | | | | | | | |
| [symbol] | P- [symbol] | 6 | 1.2 | 3.6 | 3 | 1.2 | | 3 | | 2 |
| agent | | | | | | | | | | |
| | Total | 100 | 100 | 100 | 100 | 100 | 100 | 100 | 100 | 100 |
| | [symbol] | ∘ | ∘ | ∘ | ∘ | ∘ | ∘ | ∘ | ∘ | ∘ |
| | [symbol] | ∘ | ∘ | ∘ | ∘ | ∘ | ∘ | ∘ | ∘ | ∘ |
| | [symbol] | ∘ | ∘ | ∘ | ∘ | ∘ | ∘ | ∘ | ∘ | ∘ |

[symbol]

indicates data missing or illegible when filed

Binder components respectively formed using Comparative Example 1 to 6 in Table 3 were prepared.

The TG, the paste formation, and the strength were evaluated in the same manner as in Examples. In Comparative Example 1 in which a solid solvent was not used, a preferable result could not be obtained in terms of each of the TG and the strength.

In Comparative Examples 2 to 4 in which 2,5-dimethyl-2,5-hexanediol was used as a solid solvent, the thixotropic agent is not contained, and a liquid solvent was contained only in an amount of 65% by mass or less with respect to the entire binder, preferable results could not be obtained in terms of the strength. In addition, in Comparative Examples 2 and 3 in which α-terpineol was used as a liquid solvent, preferable results could not be obtained in terms of the paste formation either. In addition, in Comparative Example 4 in which isooctadecanol was used as a liquid solvent, preferable results could not be obtained in terms of the TG either.

In Comparative Examples 5 and 6 in which 2,5-dimethyl-2,5-hexanediol was used as a solid solvent and a content of the thixotropic agent was 15% by mass or more, preferable results could not be obtained in terms of each of the TG and the strength.

TABLE 3

| | | Comparative | Comparative | Comparative | Comparative | Comparative | Comparative |
|---|---|---|---|---|---|---|---|
| | | Example 1 | Example 2 | Example 3 | Example 4 | Example 5 | Example 6 |
| Solid | 2,5-dimethyl-2,5- | | 70 | 35 | 35 | 35 | 35 |
| solvent | hexanediol | | | | | | |
| Liquid | Isobornyl | 40 | | | | | |
| solvent | cyclohexanol | | | | | | |
| Liquid | 2-ethyl-1,3- | 40 | | | | | |
| solvent | hexanediol | | | | | | |
| Liquid | α-terpineol | | 30 | 65 | | 45 | 50 |
| solvent | (terpineol) | | | | | | |
| Liquid | Isooctadecanol | | | | 65 | | |
| solvent | | | | | | | |
| Thixotropic | Stearic acid | 8 | | | | 8 | 6 |
| agent | amide | | | | | | |
| Thixotropic | P-toluamide | 12 | | | | 12 | 9 |
| agent | | | | | | | |
| | Total | 100 | 100 | 100 | 100 | 100 | 100 |
| | TG | x | ∘ | ∘ | x | x | x |
| | Paste formation | ∘ | x | x | ∘ | ∘ | ∘ |
| | Strength | x | x | x | x | x | x |

In addition, when precipitation performance for 30% by mass of 2,5-dimethyl-2,5-hexanediol was confirmed, it was confirmed that the precipitation performance of 2,5-dimethyl-2,5-hexanediol was extremely excellent in the case of α-terpineol, and it was also confirmed that it is beneficial to employ α-terpineol in the case of using 2,5-dimethyl-2,5-hexanediol.

### REFERENCE SIGNS LIST

10, 20, 30 metal part
50 brazing paste

1. A brazing paste comprising:
80% by mass or more and 95% by mass or less of a brazing material; and
5% by mass or more and 20% by mass or less of a binder,
wherein the binder contains a solid solvent containing two or more hydroxyl groups and having 5 to 7 carbon atoms, and a liquid solvent.

2. A brazing paste comprising:
a brazing material in an amount of 80% by mass or more and 95% by mass or less; and
a binder in an amount of 5% by mass or more and 20% by mass or less,
wherein the binder contains a solid solvent containing two or more hydroxyl groups and having 8 to 10 carbon atoms, and a liquid solvent,
(1) when the binder does not contain a thixotropic agent, the liquid solvent is contained in an amount of 68% by mass or more with respect to a total of the binder, and
(2) when the binder contains a thixotropic agent, the thixotropic agent is contained in an amount of 11% by mass or less with respect to a total of the binder.

3. The brazing paste according to claim 1, wherein
the brazing material contains metal,
an oxygen concentration in the metal is 1000 ppm or less, and
the brazing material does not contain boric acid and borax.

4. The brazing paste according to claim 1, wherein a TG residue at 250° C. when being measured at a temperature increase rate of 10° C./min from 25° C. to 450° C. is 0% by mass or more and 1% by mass or less.

5. The brazing paste according to claim 1 containing any one or more of 2,5-dimethyl-2,5-hexanediol, trimethylolpropane, and neopentyl glycol as the solid solvent of the binder.

6. The brazing paste according to claim 1 containing any one or more of terpineol, isobornyl cyclohexanol, butyl carbitol, tripropylene glycol monobutyl ether, phenyl glycol, hexylene glycol, tetraethylene glycol dimethyl ether, and isooctadecanol as the liquid solvent of the binder.

7. The brazing paste according to claim 2, wherein
the brazing material contains metal,
an oxygen concentration in the metal is 1000 ppm or less, and
the brazing material does not contain boric acid and borax.

8. The brazing paste according to claim 2, wherein a TG residue at 250° C. when being measured at a temperature increase rate of 10° C./min from 25° C. to 450° C. is 0% by mass or more and 1% by mass or less.

9. The brazing paste according to claim 2 containing any one or more of 2,5-dimethyl-2,5-hexanediol, trimethylolpropane, and neopentyl glycol as the solid solvent of the binder.

10. The brazing paste according to claim 2 containing any one or more of terpineol, isobornyl cyclohexanol, butyl carbitol, tripropylene glycol monobutyl ether, phenyl glycol, hexylene glycol, tetraethylene glycol dimethyl ether, and isooctadecanol as the liquid solvent of the binder.
